(19) United States
(12) Patent Application Publication
(10) Pub. No.: US 2009/0255923 A1
(43) Pub. Date: Oct. 15, 2009

(54) Induction Heating Method

(75) Inventors: Carsten Buehrer, Bonn (DE); Christoph Fuelbier, Lohmar (DE); Ingolf Hahn, Bonn (DE)

Correspondence Address: EDELL, SHAPIRO & FINNAN, LLC, 1901 RESEARCH BOULEVARD, SUITE 400, ROCKVILLE, MD, 20850, US

(73) Assignee: ZENERGY POWER GMBH, Rheinbach (DE)

(21) Appl. No.: 12/478,033

(22) Filed: Jun. 4, 2009

Related U.S. Application Data
(63) Continuation of application No. PCT/EP2008/005647, filed on Jul. 10, 2008.

(30) Foreign Application Priority Data
Jul. 26, 2007 (DE) 102007034970.1

(51) Int. Cl. H05B 6/10

(52) U.S. Cl. 219/635

(57) ABSTRACT

During induction heating of a billet of an electrically conducting material by rotating the billet relative to a magnetic field that is generated by means of at least one direct-current-carrying superconducting winding on an iron core, the reverse-induction voltage can be reduced when a direct current is generated and maintained in the winding at a value that generates in the iron core at least in the region of the winding a magnetic flux density at which the relative permeability of the material of the iron core is less than in a zero-current state of the winding.

### CROSS REFERENCE TO RELATED APPLICATIONS

This application is a continuation of International Application No. PCT/EP2008/005647, filed on Jul. 10, 2008, entitled “Induction Heating Method,” which claims priority under 35 U.S.C. §119 to Application No. DE 102007034970.1 filed on Jul. 26, 2007, entitled “Induction Heating Method,” the entire contents of which are hereby incorporated by reference.

### FIELD OF THE INVENTION

The present invention relates to a method of induction heating a billet of an electrically conducting material by relative movement between the billet and a magnetic field and, in particular, to an induction heating method in which the billet is rotated in a magnetic field that is generated utilizing at least one direct-current-fed, superconducting winding on an iron core.

### BACKGROUND

In a typical induction heating method, a cylindrical billet clamped in a clamping device driven for rotation can be rotated at a constant rotation number about its cylinder axis in a magnetic field generated via a constant current through the superconducting winding. As a result, a substantially constant current is induced in the billet. In practice, however, the billet is generally not optimally cylindrical and/or not exactly clamped; consequently, it is not rotated about its cylinder axis. Therefore, the amount of magnetic flux through the billet varies such that, correspondingly, an induced current of non-constant amount is induced in the billet. The induced current I_{ind}(t) alternates with the rotation frequency f, i.e., I_{ind}(t)=I_{ind}(t+f⁻¹). Owing to the temporally non-constant induced current in the billet, a corresponding, temporally-varying magnetic field is generated, which permeates the superconducting winding and induces a voltage therein. This effect is called a back- or reverse-induction, and the corresponding voltage a back- or reverse-induction voltage. Owing to this temporally-varying, reverse-induction voltage, no temporally constant, but a temporally-varying current flows through the superconducting winding, which leads to undesired losses, so-called back- or reverse-induction losses in the superconducting winding.

Similarly, during the heating of non-cylindrical rod-shaped billets (e.g., having a rectangular or oval cross-section), rotation of the billet generates a continuously alternating induced current, which causes a correspondingly alternating reverse-induction voltage and therewith corresponding reverse-induction losses.

Temporally-varying, reverse-induction voltages and consequent reverse-induction losses occur independently of the shape of the billets, particularly at the beginning and the end of the induction heating, when the billet is set into rotation or stopped, respectively. Basically, the reverse-induction losses arise at each change of the rotation speed.

These reverse-induction losses must be compensated by a correspondingly powerful current source. In addition, the cooling power needed for the superconducting winding must be increased.

It has been proposed to heat an electrically conducting billet in an alternating magnetic field. For conducting the magnetic flux through the billet, an alternating-current fed conductor is seated in a U-shaped yoke. With a direct-current fed additional coil seated on a section of the yoke, the section can be driven to magnetic saturation. Therefore, the magnetic flux of the alternating-current field is no longer completely conducted to the billet, and this is locally heated less strongly in a corresponding region.

Thus, it would be desirable to reduce the reverse-induction losses in the superconducting winding when performing an induction heating method.

### SUMMARY

The present invention is directed toward an induction heating method in which at least one billet is moved relative to a magnetic field. For this it is not decisive whether the magnetic field is rotated around the billet, or vice versa. A direct current is generated and maintained at a value, which generates in the iron core, at least in the region of the winding, a magnetic flux density at which the relative permeability of the material of the iron core is smaller than in a zero-current state of the winding. Because the relative permeability is reduced, the reverse-induction is diminished, and with it, the losses in the superconducting winding. At the same time, the effect of the iron-core in conducting the magnetic field of the winding is maintained. As a result, the reverse-induction is reduced.

The above and still further features and advantages of the present invention will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The invention is further illustrated with the aid of the drawings. Shown in a schematically simplified form and by way of example by

FIG. 1 illustrates a schematic view of an induction heater.

FIG. 2a illustrates a magnet system in accordance with an embodiment of the present invention, showing an induction heater with a rod-shaped iron core.

FIG. 2b illustrates a side view of the magnet system shown in FIG. 2a.

FIG. 3a illustrates a magnet system in accordance with an embodiment of the present invention, showing a U-shaped iron core.

FIG. 3b illustrates a front view of the magnet system shown in FIG. 3a.

FIG. 4a illustrates a magnet system in accordance with an embodiment of the present invention, showing an induction heater having an E-shaped yoke as an iron core.

FIG. 4b illustrates a front view of the magnet system shown FIG. 4a; and

FIG. 5 illustrates a graph showing the reverse-induction voltage as a function of the winding current.

Like reference numerals in the various figures are utilized to designate like components.

### DETAILED DESCRIPTION

The present invention is directed toward an induction heating method in which at least one billet is moved relative to a magnetic field. For example, the magnetic field may be rotated around the billet, or vice versa. A direct current is generated and maintained at a desired value, which generates in the iron core (at least in the region of the winding) a magnetic flux density at which the relative permeability of the material of the iron core is smaller than in a zero-current state of the winding. Because the relative permeability is reduced, the reverse-induction is diminished and with it, the losses in the superconducting winding. At the same time, the effect of the iron-core in conducting the magnetic field of the winding is maintained. As a result, the reverse-induction is reduced.

If two or more billets are simultaneously rotated in a magnetic field generated by the superconducting winding, then in accordance with another embodiment of the invention, the positions of the billets relative to each other can be regulated so that the reverse-induction voltages generated by the alternating induced currents of the billets are subtractively superposed. If, in a simplified representation, the magnetic field in the region of a billet is assumed to be homogeneous, then the magnetic flux through the billet is approximately proportional to the area of a projection of the billet onto a plane perpendicular to the field lines. During the heating of a non-cylindrical billet in the magnetic field, the area of the projection will change with each change of angle. The goal is to regulate the position of two or more billets relative to each other so that the summed areas of projection of all billets during their movement in the magnetic field does not change or changes as little as possible. Accordingly, the summed magnetic flux through the billets also does not change or changes only minimally, which leads to a minimized reverse-induction voltage in the winding. Stated another way, the reverse induction voltages assigned to the individual billets (i.e., the reverse induction voltages that are caused by their respective changes of the magnetic flux) are subtractively superposed.

By way of example, two identical cuboid-shaped billets having a square cross-section can be each rotated about its respective longitudinal axis at the same angular speed. Each billet, moreover, can be aligned to have this longitudinal axis at least approximately orthogonal to the field lines of the magnetic field generated by the current-carrying winding, with the position of the billets relative to each other being regulated so that the two billets are rotationally displaced relative to each other by approximately 45° about their parallel longitudinal axes. With this configuration, the magnetic flux through one of the billets will increase by the same amount by which it decreases through the other billet. When the flux through the one billet has attained its maximum, it will subsequently diminish, with the flux through the other billet increasing by the same amount. Preferably, the summed magnetic flux through the billets is constant or substantially constant. Consequently, the reverse-induction voltages to be assigned to the individual billets cancel each other at least partly by being subtractively superposed. The same effect, even if not as pronounced, if achieved when two cuboid-shaped billets with non-congruent cross-sectional areas are simultaneously heated. This is particularly applicable to cuboid-shaped billets having a pronounced rectangular cross-section.

In accordance with another embodiment of the invention, during the simultaneous induction heating of two or more billets being rotated in a magnetic field that is generated by a direct-current fed superconducting winding, the movement of the billets relative to each other can be regulated so that the reverse-induction voltages generated by the temporally-varying induced currents are subtractively superposed. As in the case of the above-described methods, with this solution, it is also necessary to rotate the billets in a magnetic field so that the sum of their projection areas is at least substantially constant. Furthermore, by regulating the movement of the billets relative to each other it is possible, alternatively or optionally, to minimize the sum of the temporal changes of the magnetic flux through the billets, which are caused by the changing rotation speeds of the individual billets relative to the magnetic field.

By way of further example, two preferably identical (e.g., cylindrical) billets rotated about their respective longitudinal axes can be rotated in opposite directions and preferably at substantially equal angular speeds. Consequently, the reverse-induction effects to be assigned to the individual billets at the beginning and at the end of the heating (i.e., during starting or stopping of the rotational movement), have different polarity signs. Consequently, in an ideal case, during starting or during stopping, an extinction of the effective reverse-induction voltage in the winding occurs by the reverse-induction voltages to be assigned to the individual billets being subtractively superposed.

The method of the present invention can be also performed during simultaneous heating of billets that differ from each other. Provided that the cross-sections of the billets have symmetries, these may be used for a purpose. For example, a first one of the cylindrical billets of the above example can be replaced with a rod-shaped one having a square cross-section, and the second cylindrical billet with a rod-shaped billet having a regular octahedral cross-section. The first billet is may be rotated at an angular speed having a value which is twice that of the second billet, and in the opposite direction from the latter. Irrespective of their shape, the billets preferably should be aligned relative to each other before the start of the rotation so that at the start of the rotational movement the magnetic flux through both billets either at first increases, or at first decreases. Preferably, at the start of the rotational movement, the projection areas of both billets in a plane perpendicular to the magnetic flux are both maximal or both minimal. If both billets are rotated in the same direction (with unchanged value of the ratio of the angular speeds to each other), the billets should be aligned before the start so that with starting of the rotational movement, the magnetic flux through one of the billets at first decreases and, through the other, at first increases. In this case, at the start of the rotational movement, the projection area of one billet is preferably maximal and the projection area of the other billet minimal. In both cases, the magnetic flux through the two billets changes oppositely such that the reverse-induction voltages to be assigned to the respective billets have different polarity signs and are subtractively superposed.

As a superconducting winding, a strip-shaped, high-temperature superconductor (HTSC) may be utilized. Exemplary HTSC are cuprate superconductors, namely, rare earth copper oxides such as YBa₂Cu₃O₇₋ₓ.

The value of the direct current can be kept at least substantially constant with a regulated current source connected to the winding. Owing to the low reverse-induction, this constant current source can have a shorter regulating range and, therefore, can be more cost-effective than when prior art methods are performed.

An exemplary device used in performing one of the above-described methods includes a superconducting winding on an iron core, a direct-current source for generating a direct current in the winding, at least one clamping device for a billet of an electrically conducting material, and a rotary drive for generating a relative movement between the winding and the clamping device. In one embodiment, the value of the direct current generated in the winding by the direct-current source is set so that the relative permeability of the iron core at least in the region of the winding is reduced when compared with the zero-current state of the winding.

If the device has at least one other clamping device driven for rotation, then the clamping devices can be driven, optionally or alternatively, in opposite directions and preferably at about the same value of the angular speed. For example, the clamping devices may be provided with suitably regulated driving motors. In addition, at least two clamping devices may be driven by a common motor. A gearing having facilities for power take-off in opposite rotational directions but at the same value of angular speed can transmit the motor power to the clamping devices.

The device may be configured to determine the reverse-induction voltages caused by the temporally varying induced currents in each of the billets. With a control mechanism that evaluates previously-determined, reverse-induction voltages, the rotary drives of the clamping devices are controlled so that the reverse-induction voltages generated by each of the billets are subtractively superposed. For example, the position of the billets relative to each other and/or the relative movement of the billets with respect to each other can be regulated by the control means.

In the simplest case, the iron core employed may be in the form of a rod. At both ends of the rod, a billet can be moved and, in particular, rotated relative to the magnetic field issuing from the rod. The return of the magnetic flux occurs via free/open space.

By way of further example, the iron core used may be in the form of a generally C-shaped or a generally U-shaped yoke. Such a yoke possesses an air-gap between two arms (pole pieces) of the yoke (which otherwise has a closed, ring-shaped cross-section) in which the billet can be rotated. An iron core of this kind provides good conduction of magnetic flux through a billet to be heated. Furthermore, as distinct from the case of a rod, the magnetic return flux takes place through the iron core.

In accordance with a preferred embodiment of the invention, the iron core is an approximately E-shaped yoke having an air gap between the middle limb/arm and each terminal or end limb or arm. Each air gap between adjacent arms is configured to accommodate a billet. The winding is disposed preferably on the middle limb. An air gap of this kind makes it possible to heat two billets at a time utilizing only one winding, as well as to conduct the magnetic return flux through the iron core. For this, one respective billet is moved relative to the magnetic field in each of the air-gaps, preferably within the air-gap.

Preferably, the iron core is formed at least partly of laminated metal sheets. This reduces possible eddy currents in the iron core. Accordingly, the eddy current power loss that heats the iron core is decreased and less measures need be taken to cool the iron core. At the same time, a possible transfer of heat from the iron core to the superconducting winding is reduced.

It is particularly preferred for the metal sheets to be disposed in layers that are substantially orthogonal to the plane in which the major part of the current induced in the billet flows. This makes possible good conduction of the magnetic field with low eddy current losses.

Preferably, the cross-section in the region of the winding is chosen to be smaller than outside the winding. Thereby, reverse-induction is further reduced.

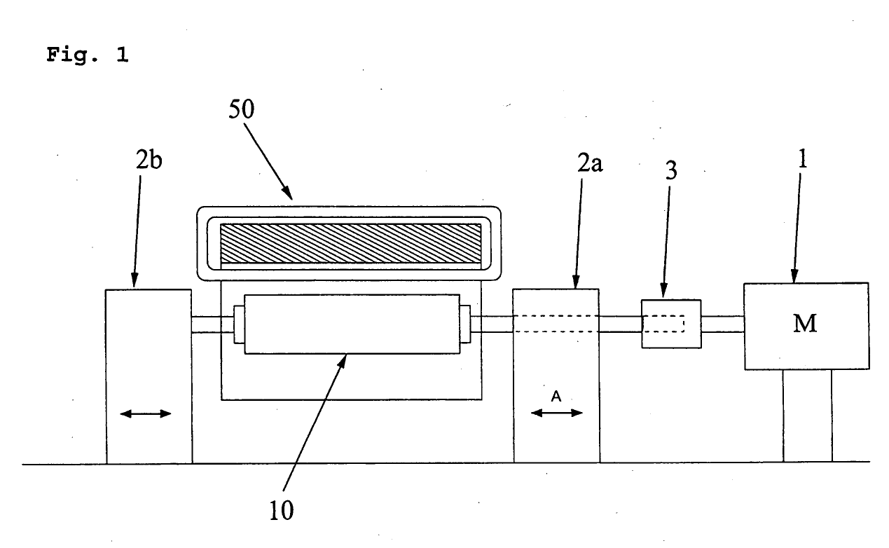

Turning to the embodiments illustrated in the figures, the induction heater in FIG. 1 serves to heat a billet 10 by rotating the billet in a magnetic field generated by a magnet system 50. For this, the billet 10 is clamped between a first (or right-hand side) pressure element 2a and a second (or left-hand side) pressure-element 2b of a clamping device. The billet 10 is driven for rotation by a motor 1. Gearing 3 connects the motor shaft to the shaft of the clamping device 2a that is adapted to slide axially along the shaft (indicated by the arrow A).

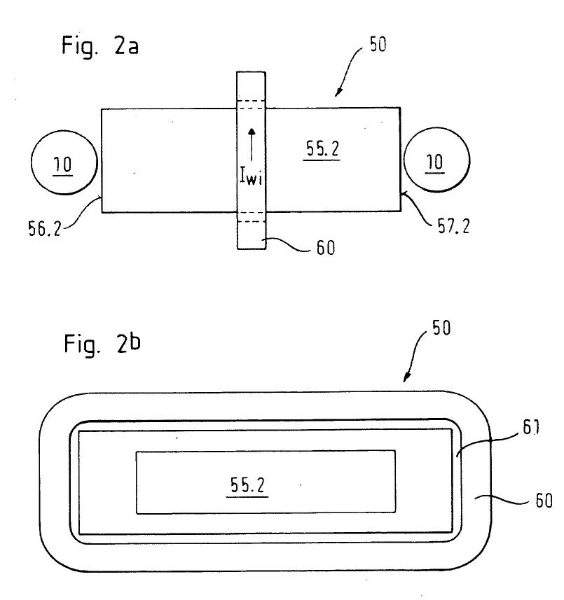

As shown in very simplified manner in FIG. 2a and FIG. 2b, the magnet system 50 may include a direct-current fed superconducting winding 60 on a rod-shaped iron core 55.2. Located between the winding 60 and the iron core 55.2 is an insulating area or element 61 that reduces the heat entering into the winding 60. By way of example, the insulating element may be an evacuated hollow space. The rod-shaped iron core 55.2 conducts the magnetic field (not shown) generated by the direct-current fed winding 60, which issues from the two end faces 56.2, 57.2 of the iron core as if from a lens, and enters the billets 10 located there via an air-gap. If the billets 10 are moved (e.g., rotated) in the magnetic field, then the magnetic flux relative to the billet changes and an induction current is induced in the billet. The current induced in the billets 10, in turn, generates another magnetic field that is superposed on the magnetic field generated by the winding 60 and reversely induces a voltage in the winding. In order for the superconducting winding 60 to operate at optimal efficiency, the temporal variation of the current flowing through the winding 60 is preferably zero, i.e., I_{wi}(t)=0. However, owing to the reverse-induction voltage which, as a rule, is not constant in time, I_{wt}(t)≠0 applies. The reverse-induction can be reduced by feeding the winding 60 with a direct current, which lowers the relative permeability preferably until just before the saturation region is attained. When the magnetic field generated by the induced current is then additively superposed on the magnetic field generated by the winding 60, the additional field strength is not or only poorly conducted to the winding 60 by the iron core 55.2 (because of the low relative permeability of the iron core), spreading out in a substantially non-conducted manner. The change of the magnetic flux through the winding 60, and with it the reverse-induction voltage, is correspondingly smaller.

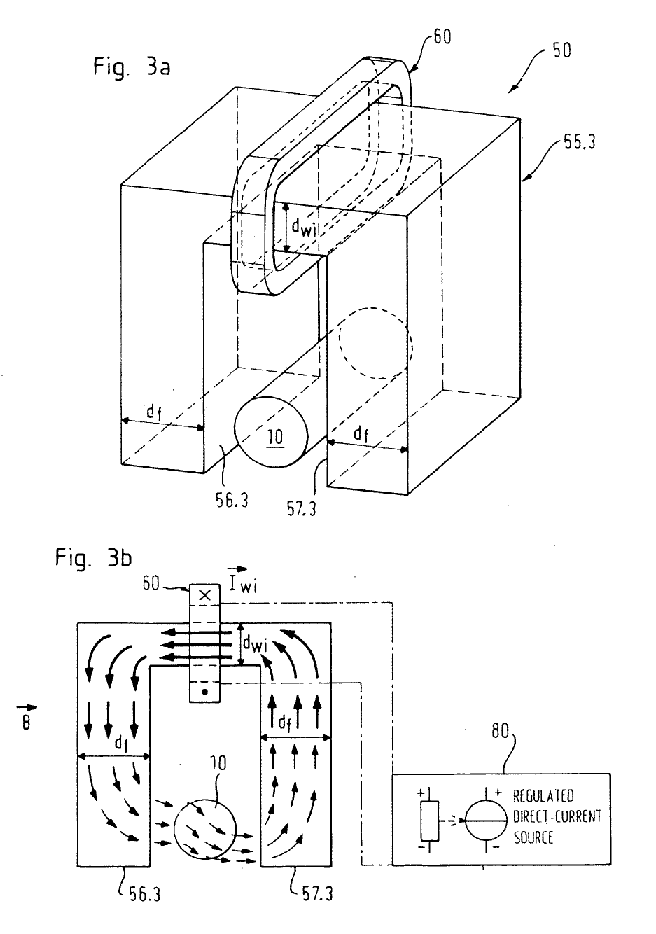

Referring to FIGS. 3a and 3b, in accordance with another embodiment of the invention, the magnet system 50 may include a substantially C-shaped or U-shaped iron core 55.3 having an HTSC winding 60.

The winding 60 is fed by a regulated direct current source 80. The iron core 55.3 conducts the generated magnetic field (indicated by the arrows in FIG. 3b). In contrast to the embodiment illustrated in FIG. 2, the magnetic return flux does not pass through free space, but through the arms or limbs 56.3, 57.3 of the core (best seen in FIG. 3b). At least one billet 10 to be heated is located between the two limbs 56.3, 57.3 of the iron core 55.3. As distinct from the illustration, the billet 10 to be heated is as a rule not exactly cylindrical, and also is in most cases not rotated exactly about its cylinder axis. Accordingly, the surface of the billet 10 permeated by the magnetic flux varies, and with it the reverse-induction, with the current through the superconducting winding also being varied. As previously described, the reverse-induction is reduced by suitable choice of the value of the direct current with which the winding 60 is fed. The cross-sectional area of the iron core 55.3 at right angles to the magnetic field (indicated by the arrows) is reduced in the region of the winding 60 in comparison with the corresponding areas of the limbs 56.3, 57.3. The reduced thickness d_{wi} of the iron core in the region of the winding 60 is evident from a comparison with the thickness d_{f} of the free limbs/arms. In this manner, the relative permeability of the iron core in the region of the winding is again reduced.

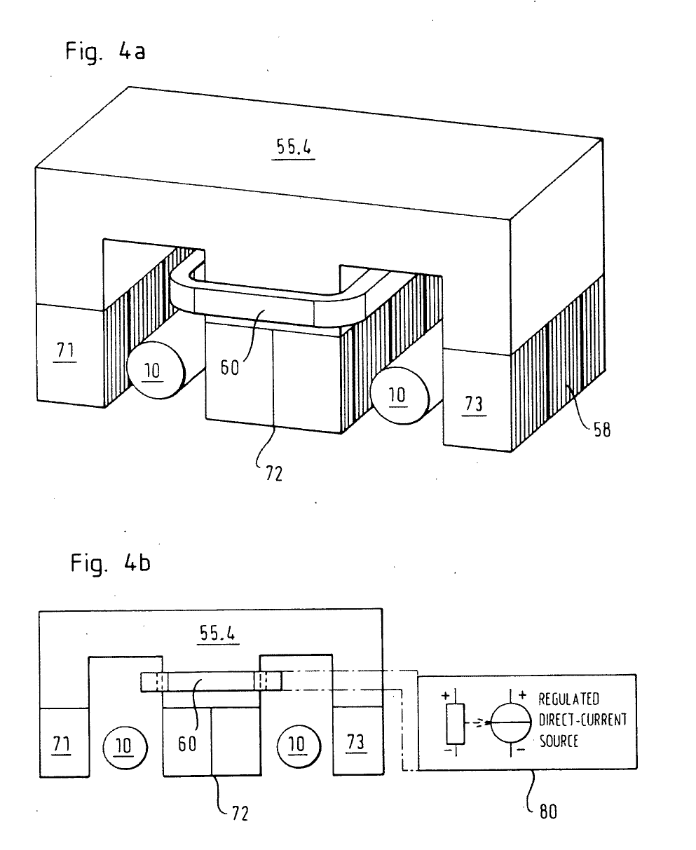

As illustrated in FIGS. 4a and 4b, the iron core 55.4 may also possess a generally E-shaped structure. A pocket in which a billet 10 is introduced is located between the free arms or limbs 71 and 72 or 72 and 73. Seated on the free middle limb or arm 72 is a coil with a high-temperature superconductor (HTSC) winding 60 that is fed by a regulated direct-current source 80. The iron core 55.4 may be formed from a plurality of laminated sheets 58 that are stacked orthogonal to the plane in which the current induced in the billets 10 flows.

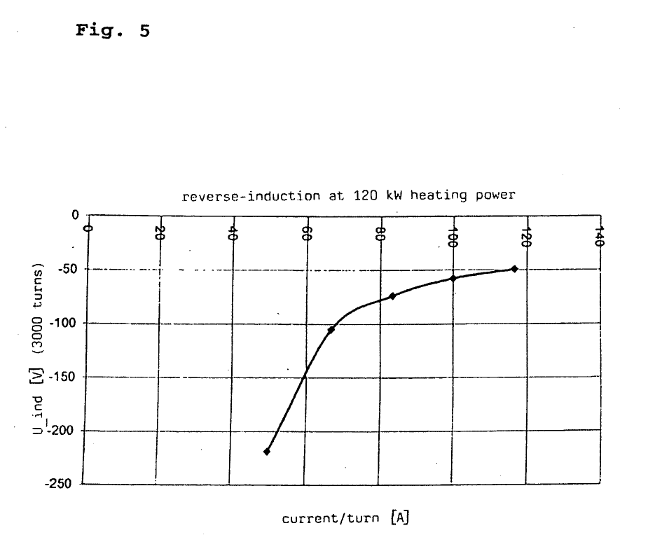

FIG. 5 shows the calculated reverse-induction voltage U_{ind} in volts as a function of the winding current I_{wi} based on 120 kW heating power, when a billet is rotated in a field of a winding having 3000 turns on an iron core, with the frequency of rotation of the billet relative to the winding changing uniformly by 8 Hz within 1 second. For small currents (for example I_{wi}≈50 A), the reverse-induction voltage has its maximum value of about 220 V. With increasing current I_{wi}, the reverse-induction at first strongly decreases in value. An increase of the current I_{wi} by about 15 A to I_{wi}≈65 A decreases the value of the reverse-induction voltage U_{ind} by about 100 V.

Above approximately 80 A, further increase of the current causes only a comparatively small reduction of the reverse-induction voltage U_{ind}, For example, an increase of the current I_{wi} from about 80 A to about 100 A causes a reduction of the reverse-induction voltage by only about 20 V.

An optimum operating range for the induction heater is between about 60 A (≈180,000 ampere-turns) and about 80 A (≈240,000 ampere-turns), especially at about 70 A (≈210,000 ampere-turns), because then the relative permeability of the iron core has a value that still permits an only small reverse-induction, but at the same time still suffices for the iron core to conduct the magnetic field generated by the superconducting winding to the billet.

What is claimed is:

1. An inductive heating method for a billet of an electrically conducting material, the method comprising:
(a) generating a magnetic field via a direct-current fed superconducting winding on an iron core; and
(b) rotating a billet formed of electrically conducting material relative to the magnetic field,
wherein the winding is fed with a direct current having a value that produces in the iron core in the region of the winding a magnetic flux density at which the relative permeability of material forming the iron core is smaller than in a zero-current state of the winding.

2. The method according to claim 1, wherein:
(b) comprises (b.1) rotating at least two electrically conducting billets relative to the magnetic field such that a temporally varying induced current is excited in each billet, causing a respective reverse-induction voltage in the winding, wherein the movement of the billets relative to each other is regulated such that that reverse-induction currents are subtractively superposed.

3. The method according to claim 2, wherein (b.1) further comprises rotating the billets in respectively opposite directions.

4. The method according to claim 2, wherein (b.1) further comprises regulating the position of the billets relative to each other such that that the reverse-induction voltages are subtractively superposed.

5. The method according to claim 2, wherein the billets are rotated at angular speeds of substantially equal values.

6. The method according to claim 1, wherein the value of the direct current through the winding is regulated to have a substantially constant value.

7. The method according to claim 1, wherein the cross-sectional thickness of the iron core in the region of the winding is less than the cross-sectional core thickness outside the region of the winding.

8. An inductive heating method for a billet of an electrically conducting material, the method comprising:
(a) generating a magnetic field, wherein the magnetic field is produced by a direct-current fed superconducting winding on an iron core;
(b) positioning a billet formed of electrically conducting material within the magnetic field;
(c) moving the billet relative to a magnetic field; and
(d) applying direct current to the winding that is operable to produce a magnetic flux density in the iron core such that the relative permeability of the iron core is less than the relative permeability of the iron core when the winding is in its zero-current state.

9. The inductive heating method of claim 8, wherein (c) comprises (c.1) rotating the billet while positioned within the magnetic field.

10. The inductive heating method of claim 8, wherein:
(b) comprises (b.1) positioning two electrically-conducting billets within the magnetic field;
(c) comprises (c.1) rotating the billets in the magnetic field to excite a temporally varying induced current in each billet; and
the method further comprises: (e) generating a reverse-induction voltage in the winding and (f) producing reverse-induction currents that are subtractively superposed by regulating the movement of the billets relative to each other.

11. The inductive heating method of claim 10, wherein (c.1) further comprises rotating the billets in opposite directions.

12. The inductive heating method of claim 10, wherein:
(c.1) further comprises rotating the billets at angular speeds of substantially equal values; and
(d) further comprises (d.1) applying a substantially constant direct current through the winding.

13. An induction heating device for induction heating of a billet comprising electrically conducting material, the device comprising
a superconducting winding mounted on an iron core;
a direct current source operable to generate a direct current in the winding; and
a clamping device operable to support the billet, wherein the clamping device is rotatably driven relative to the winding,
wherein the value of the direct current generated in the winding by the direct-current source is set so that the relative permeability of the iron core is reduced in the region of the winding when compared with that in the zero-current state of the winding.

14. The induction heating device according to claim 13 wherein:
the induction heating device is configured to inductively heat at least two billets formed of electrically conducting material;
the induction heating device further comprises at least two clamping devices rotatably driven relative to the winding, each clamping device being configured to clamp a respective billet; and
the at least two clamping devices are configured to rotate in opposite directions.

15. The induction heating device according to claim 13, wherein:
the induction heating device is operable to inductively heat at least two billets formed of electrically conducting material; and
the induction heating device further comprises:
at least two clamping devices that are rotatably driven relative to the winding, wherein each clamping device is operable to clamp a respective billet,
a mechanism operable to determine reverse-induction voltages caused in each of the billets by temporally varying induced currents, and
a rotation control mechanism operable to control the rotation of each of the clamping devices such that the reverse-induction voltages generated are subtractively superposed.

16. The induction heating device of claim 15, wherein the clamping devices are driven at angular speeds having substantially equal values.

17. The induction heating device according to claim 15, wherein the iron core comprises a generally E-shaped yoke including:
a middle arm disposed between first and second end arms; and
a gap defined between the middle arm and a respective end arm, wherein each gap accommodates a respective billet.

18. The induction heating device according to claim 13, wherein the iron core comprises a substantially U-shaped yoke.

19. The induction heating device according to claim 13, wherein the iron core comprises laminated metal sheets.

20. The induction heating device according to claim 13, wherein the iron core possesses a cross-sectional thickness that is smaller in the region surrounded by the winding than in the region located outside of the winding.
